(19) United States
(12) Patent Application Publication
(10) Pub. No.: US 2014/0365453 A1
(43) Pub. Date: Dec. 11, 2014

(54) PROJECTING ANALYTICS BASED ON CHANGES IN SEARCH ENGINE OPTIMIZATION METRICS

(71) Applicant: CONDUCTOR, INC., New York, NY (US)

(72) Inventor: MARTIN LUIS ALONSO LAGO, San Francisco, CA (US)

(21) Appl. No.: 13/911,658

(22) Filed: Jun. 6, 2013

(51) Int. Cl. G06F 17/30

(52) U.S. Cl. CPC G06F 17/30864
USPC 707/706

(57) ABSTRACT

A system and method effective to generate search engine report data to be displayed on a display. A processor may send a keyword to a search engine and receive a result set. The processor may generate historical search engine report data based on the keyword, a URL and the result set. The historical search engine report data may include a first value of an analytic for the keyword and/or URL when a metric relating to the keyword and/or the URL is at a first metric value. The processor may send the historical search engine report data to a second processor and receive an objective when the metric is at a second metric value. The processor may analyze the request with respect to the historical search engine report data to produce projected search engine report data. The projected search engine report data may include a second value of the analytic.

### BACKGROUND OF THE INVENTION

In a prior art search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Users may modify web pages in an attempt to have their page appear higher in a result set for particular queries. This disclosure describes an improvement over these prior art technologies.

### SUMMARY OF THE INVENTION

One embodiment of the invention is a method for generating search engine report data. The method may include, by a first processor, receiving a keyword and a URL. The method may include sending the keyword to a search engine. The method may include receiving a result set from the search engine based on the keyword. The method may include generating historical search engine report data based on the keyword, the URL and the result set, the historical search engine report data including a first value of an analytic for the keyword and/or URL when a metric relating to the keyword and/or the URL is at a first metric value. The method may include sending the historical search engine report data to a second processor. The method may include receiving a request, wherein the request includes an objective when the metric is at a second metric value. The method may include analyzing the request with respect to the historical search engine report data to produce projected search engine report data, wherein the projected search engine report data includes a second value of the analytic.

Another embodiment of the invention is a device effective to generate report data to be displayed on a display. The device may include a memory and a first processor configured in communication with the memory. The first processor may be effective to receive a keyword and a URL. The first processor may be effective to send the keyword to a search engine. The first processor may be effective to receive a result set from the search engine based on the keyword. The first processor may be effective to generate historical search engine report data based on the keyword, the URL and the result set, the historical search engine report data including a first value of an analytic for the keyword and/or URL when a metric relating to the keyword and/or the URL is at a first metric value. The first processor may be effective to send the historical search engine report data to a second processor. The first processor may be effective to receive a request, wherein the request includes an objective when the metric is at a second metric value. The first processor may be effective to analyze the request with respect to the historical search engine report data to produce projected search engine report data, wherein the projected search engine report data includes a second value of the analytic.

Another embodiment of the invention is a system effective to generate report data to be displayed on a display. The system may include a first processor and a second processor configured in communication with the first processor over a network. The second processor may be effective to send a keyword and URL to the first processor. The first processor may be effective to receive the keyword and the URL. The first processor may be effective to send the keyword to a search engine. The first processor may be effective to receive a result set from the search engine based on the keyword. The first processor may be effective to generate historical search engine report data based on the keyword, the URL and the result set, the historical search engine report data including a first value of an analytic for the keyword and/or URL when a metric relating to the keyword and/or the URL is at a first metric value. The first processor may be effective send the historical search engine report data to the second processor. The second processor is effective to receive the historical search engine report data and generate a request, wherein the request includes an objective when the metric relating to the keyword and/or URL is at a second value. The first processor is effective to receive the request; and analyze the request with respect to the historical search engine report data to produce projected search engine report data, wherein the projected search engine report data includes a second value of the analytic.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system in accordance with an embodiment of the invention.

FIG. 2 is a drawing illustrating a user interface in accordance with an embodiment of the invention.

FIG. 3 is a drawing illustrating more detail of a module of the user interface of FIG. 2 in accordance with an embodiment of the invention.

FIG. 4 is a drawing illustrating more detail of a module of the user interface of FIG. 2 in accordance with an embodiment of the invention.

FIG. 5 is a drawing illustrating a detailed view of the user interface of FIG. 2 in accordance with an embodiment of the invention.

FIG. 6 is a drawing illustrating a user interface in accordance with an embodiment of the invention.

FIG. 7 is a drawing illustrating more detail of a module of the user interface of FIG. 6 in accordance with an embodiment of the invention.

FIG. 8 is a flow chart illustrating a process which may be performed in accordance with an embodiment of the invention.

### DETAILED DESCRIPTION OF THE PREFERRED EMBODIMENT(S)

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

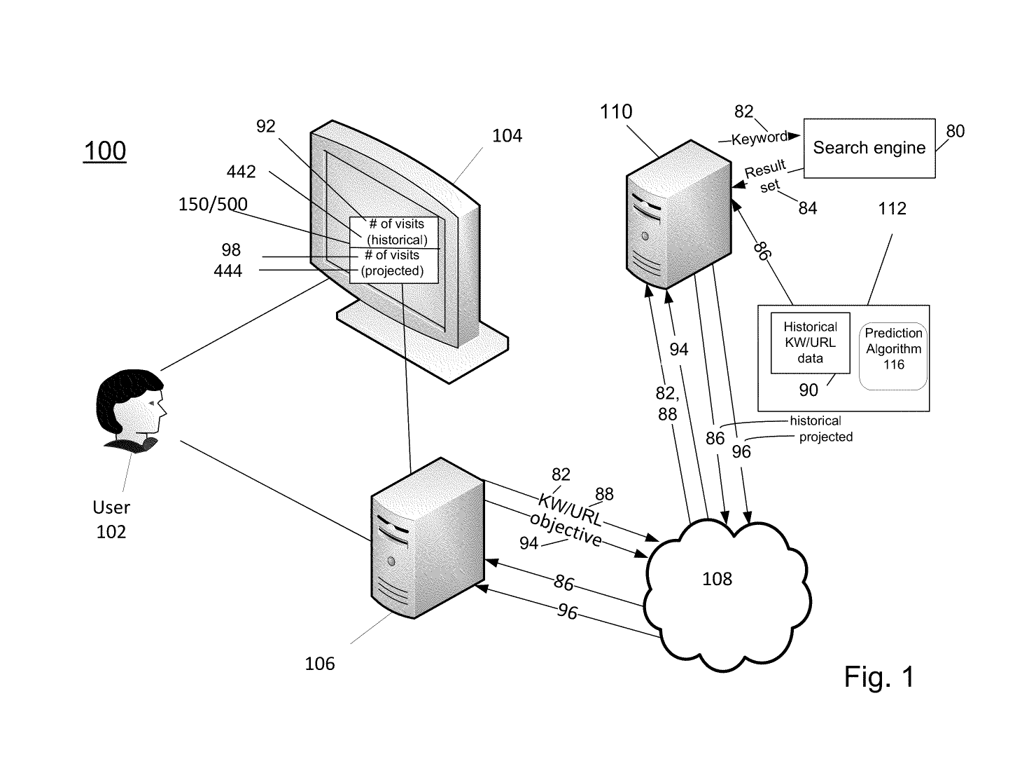

FIG. 1 is a system drawing of a system in accordance with an embodiment of the invention. System 100 may include a display 104, a processor 106, and/or a processor 110, all configured in communication through a network 108. Network 108 could include, for example, the Internet or a Local Area Network (LAN). Processor 110 may be in communication with a memory 112. Memory 112 may include a prediction algorithm 116 and/or historical keyword/URL data 90. Processor 106 may be in communication with display 104. Display 104 may be configured to display a user interface 150 and/or a user interface 500 which may include reports as discussed in more detail below.

In use, a user 102 may use processor 106 to send one or more keywords (“KW”) 82 and URLs (Uniform Resource Locators) 88 through network 108 to processor 110. Each keyword 82 could be, for example, one or more characters, symbols, operators, and/or words. Processor 110 may receive keywords 82 and URLs 88. Processor 110 may send keywords 82 to a search engine 80 and receive one or more result sets 84 based on keywords 82. Processor 110 may generate and store historical keyword/URL data 90 in memory 112 based on keyword 82, URL 88 and result set(s) 84.

Processor 110 may send a subset 86 of historical keyword/URL data to processor 106 through network 108. Processor 106 may receive subset of historical keyword/URL data 86 and generate a historical keyword/URL report 92 to be displayed on display 104 using user interface 150. Historical keyword/URL report 92 may include a historical visit field 442 displaying a historical number of visits to URL 88. Historical keyword/URL report 92 is based on historical values of metrics relating to keyword 82 and/or URL 88.

User 102 may view, save, and/or modify historical keyword/URL report 92. User 102 may request a modification of historical keyword/URL report 92 by using processor 106 to send an objective 94 to processor 110 through network 108. Objective 94 may be, for example, a new value of a metric relating to keyword 82, URL 88 and/or another search engine optimization metric. Processor 110 may receive objective 94. Processor 110 may use a prediction algorithm 116 to analyze objective 94 with respect to historical keyword/URL data 90 to produce projected keyword/URL data 96. Processor 110 may send projected keyword/URL data 96 to processor 106 through network 108. Processor 106 may receive projected keyword/URL data 96 and generate a modified report 98 to be displayed on display 104 using user interface 150. Modified report 98 may include the same or more details as historical keyword/URL report 92 and may replace historical keyword/URL report 92 on user interface 150. Modified report 98 may include a projected visit field 444 displaying a projected number of visits to URL 88. User 102 may view, save, and/or modify modified report 98.

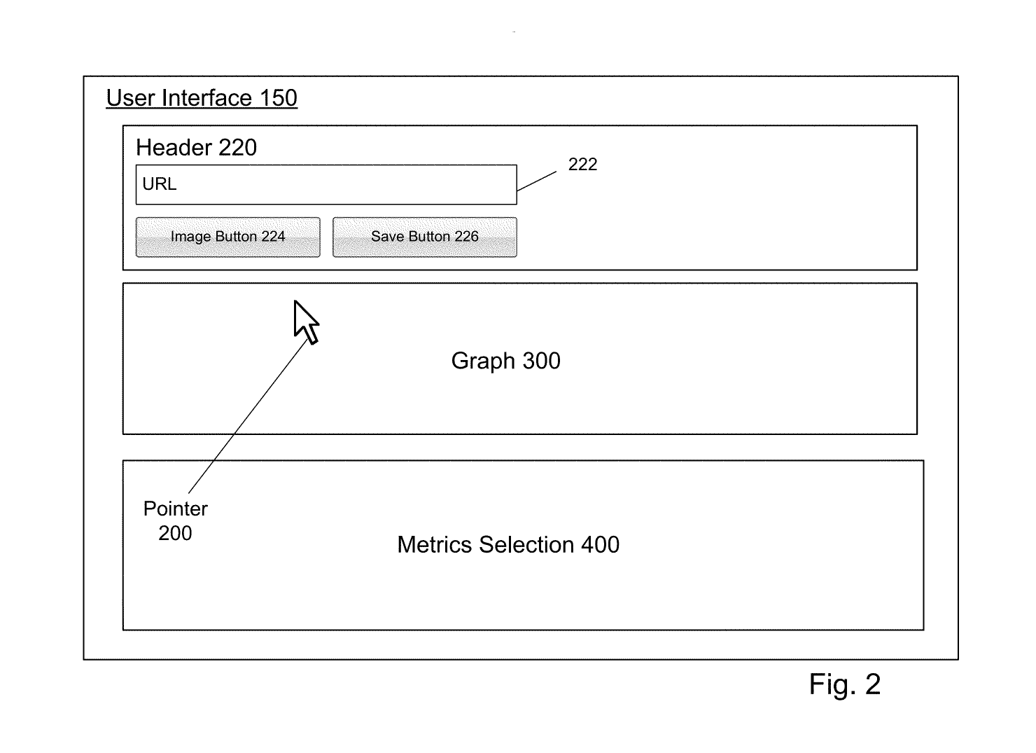

FIG. 2 is a drawing illustrating a user interface in accordance with an embodiment of the invention. User interface 150 may include a header module 220, a graph module 300, and/or a metrics selection module 400. Header module 220 may include a field 222, an image button 224 and/or a save button 226. A pointer 200 may be used by users for navigation within the boundaries of user interface 150. Navigation of pointer 200 may be controlled by an input device, such as computer mouse or keyboard.

Field 222 may display URL 88. Selection of image button 224 may enable a user to modify a display of contents in graph module 300 (discussed below). Contents displayed by selecting image button 224 may include a more detailed view and/or a larger version of contents in graph module 300. Selection of save button 226 may allow a user save a report being viewed.

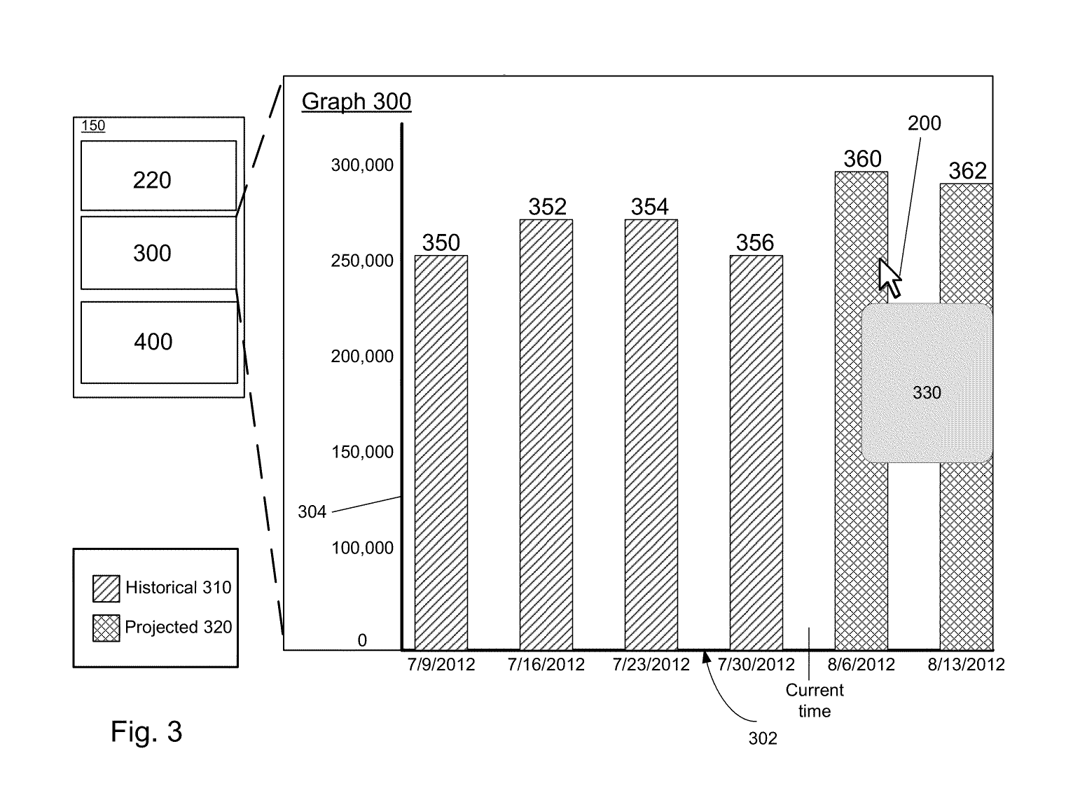

FIG. 3 is a drawing illustrating more detail of a module of user interface 150 of FIG. 2 in accordance with an embodiment of the invention. As shown, user interface 150 includes both historical keyword/URL report 92 reflecting historical data and modified report 98 reflecting projected data. Graph module 300 may include a timeline axis 302, and analytics axis 304 represented by a number of visitors. Timeline axis 302 may include time units, which are separated by the same time interval. Time units on timeline axis 302 may be represented as time and/or date. Values on number of visitors axis 304 may represent a number of visits from a search engine results page to a URL corresponding to URL 88 and/or the URL displayed in field 222. Graph module 300 may display a visual representation of visits to URL 88 corresponding to each time unit displayed on timeline 302. In an example, visual representations in graph 300 may be vertical shaded or colored bars 350, 352, 354, 356, 360, 362 in horizontal arrangement along timeline 302.

In the example shown, bars 350, 352, 354, 356, 360, 362 may be shaded or colored in two different shades or colors: historical shade or color 310 and projected shade or color 320. Historical shade or color 310 may represent a number of historical and/or previous visits to URL 88. Projected shade or color 320 may represent projected visits to the URL 88. In the example, bars 360 and 362 may relate to projected values of visits. Such projected values may be based on objective 94 including a new value for a metric—as discussed in more detail below.

Projected values of an analytic may be based on selections in metrics module 400. Such selections may correspond to objective 94 (FIG. 1). For example, assuming today's date is 8/2/2012, vertical shaded bars 350, 352, 354, and 356 may represent visits to the URL 88 on 7/9/2012, 7/16/2012, 7/23/2012, and 7/30/2012, respectively. Bars 360 and 362 may represent projected visits to URL 88 on 8/6/2012 and 8/13/2012, respectively based on values for metrics in objective 94.

Graph 300 may provide hover type information for a user. For example, user 102 may navigate pointer 200 to bar 360 in graph 300. When pointer 200 is at a location corresponding to bar 360, a communication signal may be sent from processor 106 to processor 110 through network 108 (FIG. 1). Processor 110 may receive the communication signal and, in response, retrieve and send data associated with bar 360 to processor 106 through network 108. Processor 106 may receive the data and provide and display additional detail for graph 300 displayed in user interface 150 on display 104. The additional detail may include data from historical keyword/URL metrics data 90 and may be displayed in a new hover detail window 330. Hover detail window 330 may be of a size smaller than the area of graph module 300 and may be configured to stay visible for a limited amount of time or until pointer 200 moves away from bar 360. Hover detail window 300 may include information such as the date of the respective vertical bar, and a historical or projected value of visits.

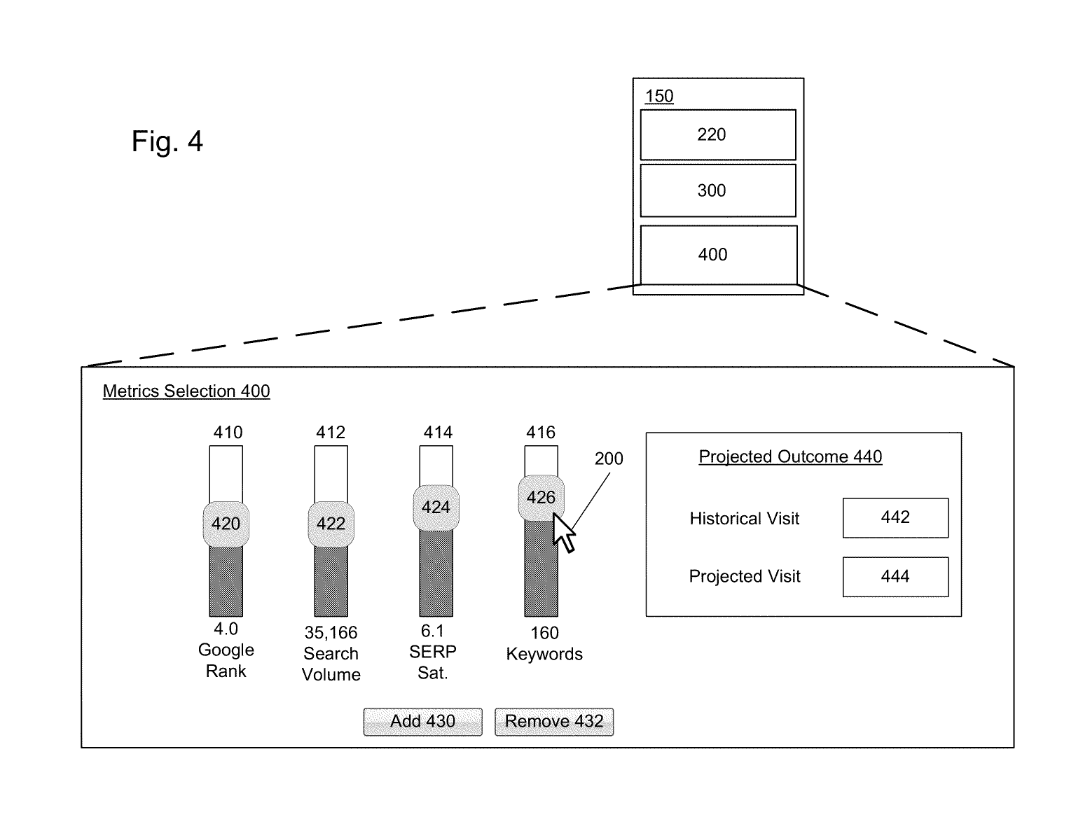

FIG. 4 is a drawing illustrating more detail of a module of the user interface of FIG. 2 in accordance with an embodiment of the invention. Metrics selection module 400 may include a projected outcome window 440, an add button 430, a remove button 432, and/or sliders 410, 412, 414, 416. Projected outcome window 440 may include a historical visit field 442 and/or a projected visit field 444. Sliders 410, 412, 414, and/or 416 may include indicators 420, 422, 424, and/or 426, respectively. Sliders 410, 412, 414 and/or 416 may identify values for search engine optimization metrics relating to keyword 82 and/or URL 88. Indicators 420, 422, 424, and/or 426 may be moveable to different positions along respective sliders. Indicators 420, 422, 424, and/or 426 may be moved by pointer 200 in an up or down direction along their respective slider. Selection of add button 430 may cause processor 110 to add one or more additional sliders relating to search engine optimization metrics. Selection of remove button 432 may cause processor 110 to remove one or more sliders.

Historical visit field 442 may display the historical number of visits to URL 88 displayed in field 222 based on values of indicators 420, 422, 426, 426 for the metrics indicated by sliders 410, 412, 414 and/or 416. Projected visit field 444 may display projected visits to URL 88 based on the values of indicators 420, 422, 426, 426 for the metrics indicated by sliders 410, 412, 414 and/or 416. A value displayed in projected visit field 444 may be higher or lower than the value in historical visit field 442. Projected visit field 444 may display the words “no change” if a value in projected visit field 444 is the same as the value in historical visit field 442.

Sliders 410, 412, 414, and/or 416 may relate to SEO metrics for keyword 82 and/or URL 88. Examples of metrics include GOOGLE Rank, Average Search Volume, Search Engine Result Page (SERP) Saturation (such as URLs per keyword), and/or number of ranking keywords (e.g. a number of keywords where a corresponding URL ranks over rank 100), etc. Each slider may have a lower bound and/or an upper bound in value. The lower bound may be located at the bottom edge of the respective slider, and the upper bound may be located at the top edge of the respective slider. Upper and lower bounds may be determined by processor 110 by a threshold percentage difference from a historical value of the metric. Such a threshold difference may indicate a practical change that may be available for the particular metric during a time period. An example time period may be 12 weeks. An example threshold may be plus or minus ten percent. For example, if a historical Search Volume is 35,166, slider 412 may have upper and lower bounds limiting movement of indicator 422 to 10 percent higher (38,000) or 10 percent lower (32,000). A value of the indicator in each slider may be displayed below the slider.

Referring also to FIG. 1, in operation, a user may view historical keyword/URL report 92. Historical keyword/URL report 92 may, for example, include historical visit field 442 indicating historical visits to URL 88 along with historical values of metrics identified by sliders 410, 412, 414, 416. The user may generate objective 94 by moving one of indicators 420, 422, 424, 426 to modify a value of one of the metrics. For example, the user may move indicator 422 of slider 412 to indicate a search volume of 40,000. The new value may correspond to objective 94. Processor 110 may use prediction algorithm 116 to analyze the new value of the metric with respect to historical keyword/URL data 90 to produce projected data 96.

For example, prediction algorithm 116 may analyze historical keyword/URL data 90 to identify past patterns and relations between values of SEO metrics and number of visits. In an example, between week 1 and week 2, visits change from 100 visits to 200 visits and the only metric that changes was the number of ranking keywords. Prediction algorithm 116 may determine that the number of visits is therefore a certain percentage of the number of ranking keywords. If more than one metric changed from one time period to another, the metrics may be isolated for the various temporal periods and solved using multi-variable analyses.

In an example, user 102 may wish to view how a GOOGLE Rank of 4.0 may affect a number of projected visits to URL 88. User 102 may use pointer 200 to select indicator 420 and move indicator 420 up or down to settle on a GOOGLE rank value of 4.0. Once indicator 420 settles on a GOOGLE Rank value of 4.0, objective 94, representing “GOOGLE Rank of 4.0”, may be sent from processor 106 to processor 110 through network 108. Processor 110 may use prediction algorithm 116 to analyze objective 94 with respect to historical keyword/URL data 90 to produce projected keyword/URL data 96. Processor 110 may send projected keyword/URL data 96 to processor 106 through network 108. Projected keyword/URL data 96 may include data for projected visit field 444. Processor may receive data for projected visit field 444 and display a projected visit value for a GOOGLE rank metric value of 4.0.

In another example, user 102 may wish to view how a SERP saturation value of 6.1 and 160 ranking keywords may affect a number of projected visits to URL 88. User 102 may use pointer 200 to select indicator 424 and move indicator 424 up or down along slider 414 to settle on a SERP saturation value of 6.1. User 102 may use pointer 200 to select indicator 426 and move indicator 426 up or down along slider 416 to settle on a ranking keywords value of 160. With these new values for the metrics SERP saturation and ranking keywords, objective 94 may be sent from processor 106 to processor 110 through network 108. Processor 110 may use prediction algorithm 116 to analyze objective 94 with respect to historical keyword/URL data 90 to produce projected keyword/URL data 96. Processor 110 may send projected keyword/URL data 96 to processor 106 through network 108. Projected keyword/URL data 96 may include data for projected visit field 444. Processor may receive data for projected visit field 444 and display a projected visit value for a SERP saturation value of 6.1 and 160 ranking keywords.

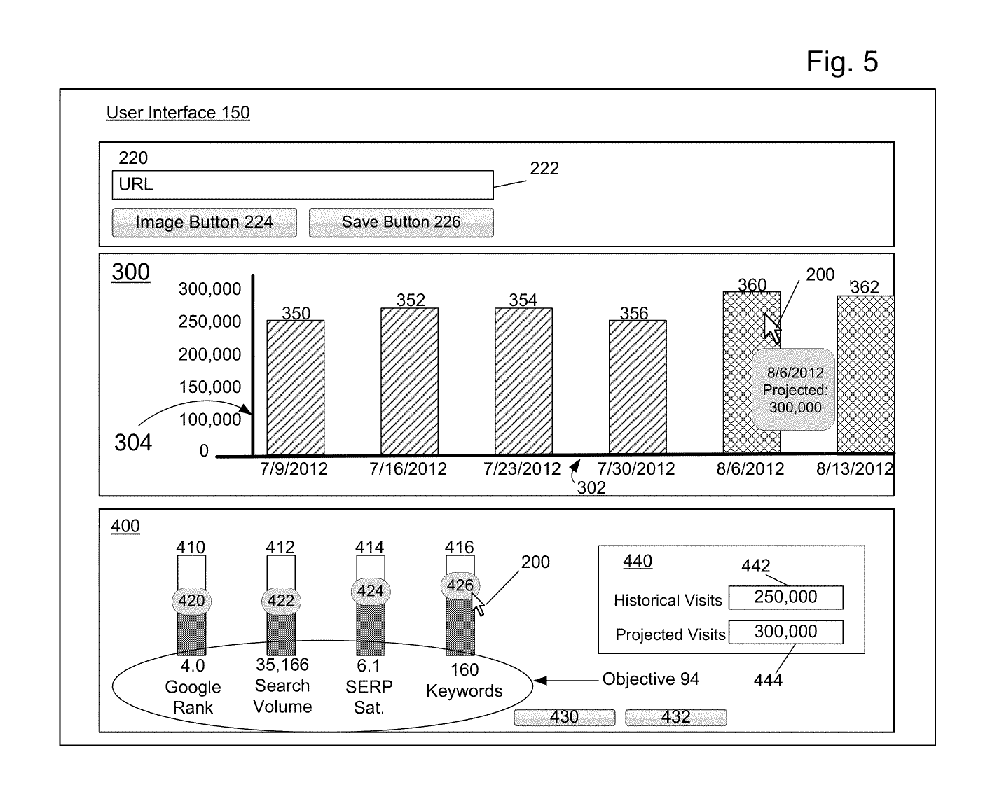

FIG. 5 is a drawing of a detailed view of user interface in accordance with an embodiment of the invention. FIG. 5 is substantially similar to user interface 150 of FIG. 2, and modules in FIG. 3 and FIG. 4, with additional details. FIG. 5 illustrates an example where the current date is 8/2/2012. Objective 94 includes a Google Rank of 4.0, Search Volume of 35,166, SERP saturation value of 6.1, and 160 ranking keywords. User 102 may use pointer 200 to navigate within the boundaries of user interface 150 and/or to change the positioning of indicators 420, 422, 424, 426 to the positions reflecting objective 94. Processor 106 may send objective 94 to processor 110 through network 108. Processor 106 may use prediction algorithm 116 to analyze objective 94 with respect to historical keyword/URL data 90 to produce projected keyword/URL data 96 which may include an analytic relating to projected visit values. Processor 110 may send projected keyword/URL data 96 to processor 106 through network 108. Processor 106 may generate modified report 98 for the analytic relating to projected visit values. In modified report 98, projected visit field 444 may display a value of projected visits and heights of bars 360 and 362 may reflect heights corresponding to values of projected visits. User 102 may save modified report 98 by selecting save button 226 with pointer 200.

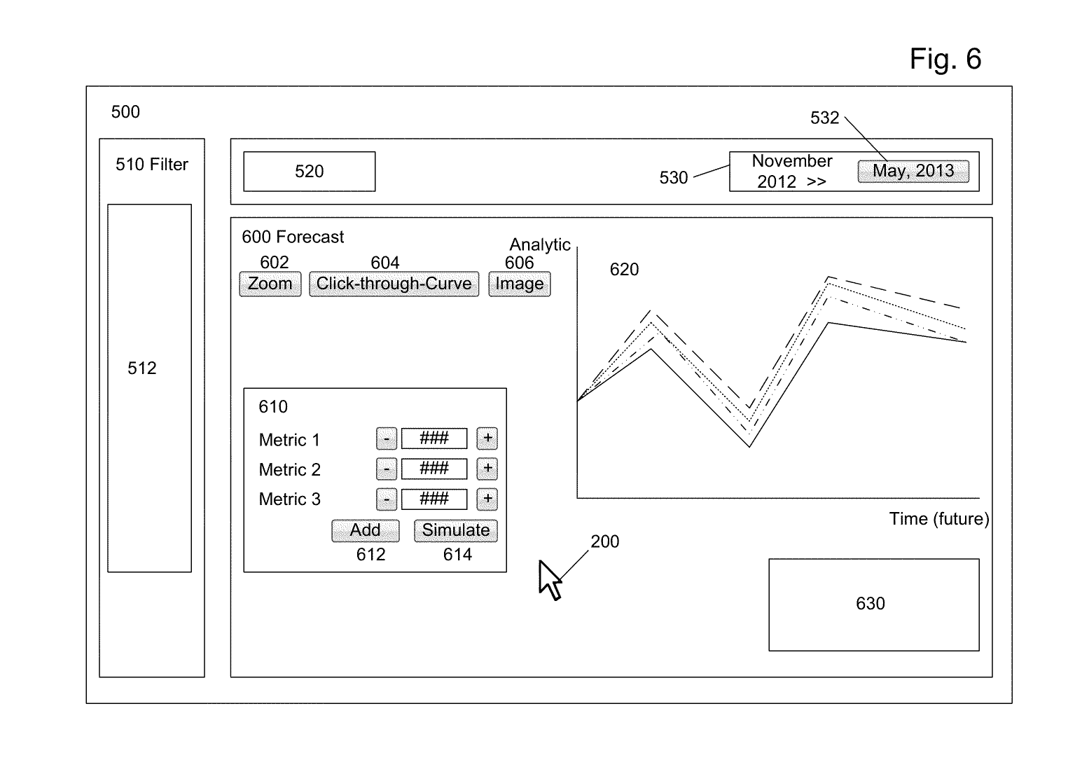

FIG. 6 is a drawing illustrating a user interface in accordance with an embodiment of the invention. User interface 500 may include a filter module 510, a title field 520, a date field 530, and/or a forecast module 600. Pointer 200 may be used by users to navigate within the boundaries of user interface 500. Filter module 510 may include a set of display options 512. Display options 512 may include items for selection by a user. Selection of these items may modify objective 94 resulting in processor 110 producing modified report 98. Data displayed in user interface 500 may be narrowed or limited upon selection of items within display options 512. For example, selection of a particular keyword in display options 512 may modify objective 94 and result in processor 110 producing modified report 98 on user interface 500 displaying information relating to the particular keyword.

Title field 520 may be used to display URL 88 (FIG. 1). Date field 530 may include a button 532. Date field 503 may display a range of dates. A first date in date field 530 may be the current month and year. A second date in date field 530 may be a later date compared to the first date. The second date may be positioned within the boundaries of button 532. The second date may be changed by selecting button 532 resulting in a change in objective 94. For example, as shown in FIG. 6, the first date is November 2012 and the second date is May 2013.

Forecast module 600 may include buttons 602, 604, and/or 606, a metrics field 610, an analytics chart 620, and/or a scenario field 630. Selection of button 602 causes a signal to be sent to processor 110 resulting in zoom functions on analytics chart 620 such as zoom in, zoom out, etc. Selection of button 606 causes a signal to be sent to processor 110 result in a viewing and/or saving of a portion of analytics chart 620. Selection of button 604 causes a signal to be sent to processor 110 resulting in further SEO data analysis as discussed in more detail below.

Metrics field 610 may identify one or more additional metrics. Each identified metric may have a corresponding textbox and/or buttons. Entry of data in the text box or selection of one or more buttons relating to a respective metric may cause a signal to be sent to processor 110 reflecting the requested change in respective metric's value. Metrics field 610 may also include buttons 612 and/or 614. Selection of button 612 may cause a signal to be sent to processor 110 resulting in additional metrics being identified in metrics field 610. Selection of button 614 may cause a signal to be sent to processor 110 resulting in a simulation to be generated based on the values of the metrics in metrics field 610. Values in analytics chart 620 and/or scenario field 630 may change based on values of metrics identified in metrics field 610 upon selection of button 614. Scenario field 630 may include data corresponding to values in analytics chart 620 as discussed in more details below. Analytics chart 620 may illustrate two or more potential outcomes based on values of metrics identified in metrics field 610.

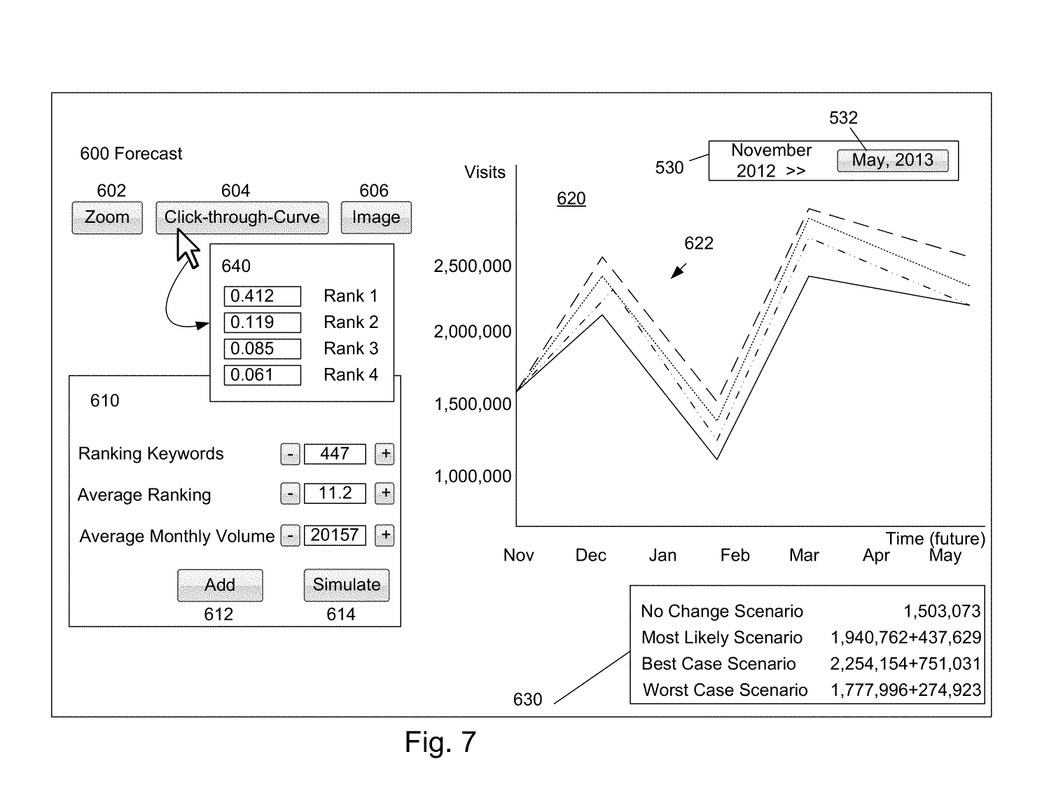

FIG. 7 is a drawing illustrating more detail of a module of the user interface of FIG. 6 in accordance with an embodiment of the invention. Selection of button 604 may cause a signal to be generated by processor 106 allowing user 102 to modify a click through curve through a window 640. If button 604 is not selected, default values for the click through curve may be used. The click through curve may indicate what percentage of users may click on respective URLs at particular ranks For example, a default click through curve may indicate that 40% of users click on a URL at position 1 and 20% of users click on a URL at position 2. An increase in rank may result in an increase in a value of corresponding analytics.

A user may choose to modify the click through curve to generate a modified click through curve in situations when the user is aware of different click through values that may be specific to the users' industry. In the example shown, the user has modified rank 1 to have a click through rate of 0.412—indicating that just over 41% of users tend to click on the result in rank 1. Similarly, in the example, the user has modified rank 2 to have a click through rate of 0.119—indicating that just under 20% of users tend to click on the result in rank 2. Values for the modified click through curve may be collected by processor 106 and used as part of objective 94.

Metrics identified in metrics field 610 may be metrics relating to SEO analysis such as “Ranking Keywords”, “Average Ranking”, and/or “Average Monthly Volume”, etc. Additional metrics may be added in metrics field 610 in response to selection of button 612. Analytics chart 620 may include a horizontal and/or a vertical axis. Values along the horizontal axis of chart 620 may represent time such as months within the date range in date field 530. Months listed along the horizontal axis may be separated by a same time interval. Values along the vertical axis of chart 620 may represent values of an analytic. The values of the analytic may be projected values generated by prediction algorithm 116. The projected values for the analytic may reflect possible scenarios that may occur in the future.

For example, vertical axis 620 may represent the analytic—number of visits to URL 88 (FIG. 1). Analytics chart 620 may include one or more curves 622 representing projected values of the analytic (e.g. projected visits to URL 88) for the months identified along horizontal axis of analytics chart 620. Each curve 622 may represent analytics values for a different distinct scenario generated by prediction algorithm 116 (FIG. 1). Scenario field 630 may include data which reflects the scenarios represented in analytics chart 620.

Example scenarios represented in analytics chart 620 and/or scenario field 630 may include “No Change Scenario”, “Most Likely Scenario”, “Best Case Scenario”, “Worst Case Scenario”, etc. Each scenario may be represented in chart 620 with a different curve. For example, curve 622 corresponding to the “No Change Scenario” may include values of an analytic that may occur if the future values of relevant metrics match previous values of the metrics. Other curves 622 may reflect scenarios that may occur when values of metrics in metrics field 610 remain fixed but values of other metrics that may affect the analytic vary. For example, ranking keywords may be fixed at 447, average ranking fixed at 11.2 and average monthly volume fixed at 20157. Prediction algorithm 116 may then iterate through values for other metrics such as SERP saturation, or GOOGLE rank to generate curves 622 based on known historical data. The worst case scenario may occur when the other metrics produce the lowest value of the analytic. The best case scenario may be when the other metrics produce the highest value of the analytic.

Prediction algorithm 116 may, for example, analyze a probability distribution between values of analytics and values of metrics. In such a probability distribution, prediction algorithm 116 may mathematically predict that an increase in a value of certain metrics may result in the same distribution of values for the measured analytic. In an example, prediction algorithm 116 may project a value of the analytic visits that may result in response to an increase in a value of the metric ranking keywords.

Referring to FIGS. 1 and 7, user 102 may view historical keyword/URL report 92. Historical keyword/URL report 92 may, for example, include data corresponding to historical visits to URL 88 along with historical values of the metrics in metrics field 610. User 102 may generate objective 94 by increasing or decreasing values of the metrics (such as by pressing the plus or minus buttons or entering text in the text fields) in metrics field 610. Processor 110 may use prediction algorithm 116 to analyze objective 94 with respect to historical keyword/URL data 90 to produce projected keyword/URL data 96. Processor 110 may send projected keyword/URL data 96 to processor 106 which may cause processor 106 to display modified report 98 including forecast module 600 and analytics chart 620.

In an example illustrated in FIG. 7, user 102 may wish to view values for the analytic number of visits to URL 88 based on 447 “Ranking Keywords”, an “Average Ranking” of 11.2, and “Average Monthly Volume” of 20,157 between now (November 2012) and a later time (May 2013). Processor 106 may collect metric values in metrics field 610 to generate objective 94. Processor 106 may send objective 94 to processor 110 through network 108. Processor 110 may use prediction algorithm 116 to analyze objective 94 with respect to historical keyword/URL data 86 to produce projected keyword/URL data 96. Processor 110 may send projected keyword/URL data 96 to processor 106 through network 108.

Projected keyword/URL data 96 may include data effective to generate one or more curves in analytics chart 620 and/or effective to generate one or more numerical values in scenario field 630. As shown in FIG. 7, projected keyword/URL data 96 includes 4 distinct scenarios. Each scenario is represented as a curve in analytics chart 620 and as numerical values in scenario field 630. Numerical representation of projected keyword/URL data 96 in scenario field 630 may include the average value of each scenario and/or the difference between each scenario and the “No Change Scenario”. Curves in analytics chart 620 may be distinguished by color and/or patterns.

In an example, a URL may rank within a certain threshold rank (e.g. top 100) for 500 keywords. While ranking within the threshold for 500 keywords, the URL may have a corresponding analytic value—e.g. the URL receives 150,000 visits. Stated another way, when the URL ranks in the top 100 for 500 keywords, the URL also receives 150,00 visits. A user may desire to see how the value of the visit analytic may change if the URL ranked within the top threshold for 600 keywords. The described system may allow the user to see this projected analytical value. A user may then identify how many more visits a URL may receive if the value of a metric is changed.

Among other potential benefits, a system in accordance with the disclosure may provide a marketing professional with guidance as to where to focus search engine optimization efforts. A user may see how a value of visits may be increased based on a change in a value of particular search engine optimization metrics. For example, an increase in value of one metric may not lead to a large change in value in visits to the user's web site whereas changes in value in another metric may produce larger changes in value in the number of visits analytic. As projected visits are based on historical data relating to a particular URL, changes in metric values may produce different values for the analytic visits for different URLs resulting in customized SEC) information. A user may determine that an increase in a certain value in a metric may yield a desired target value of an analytic.

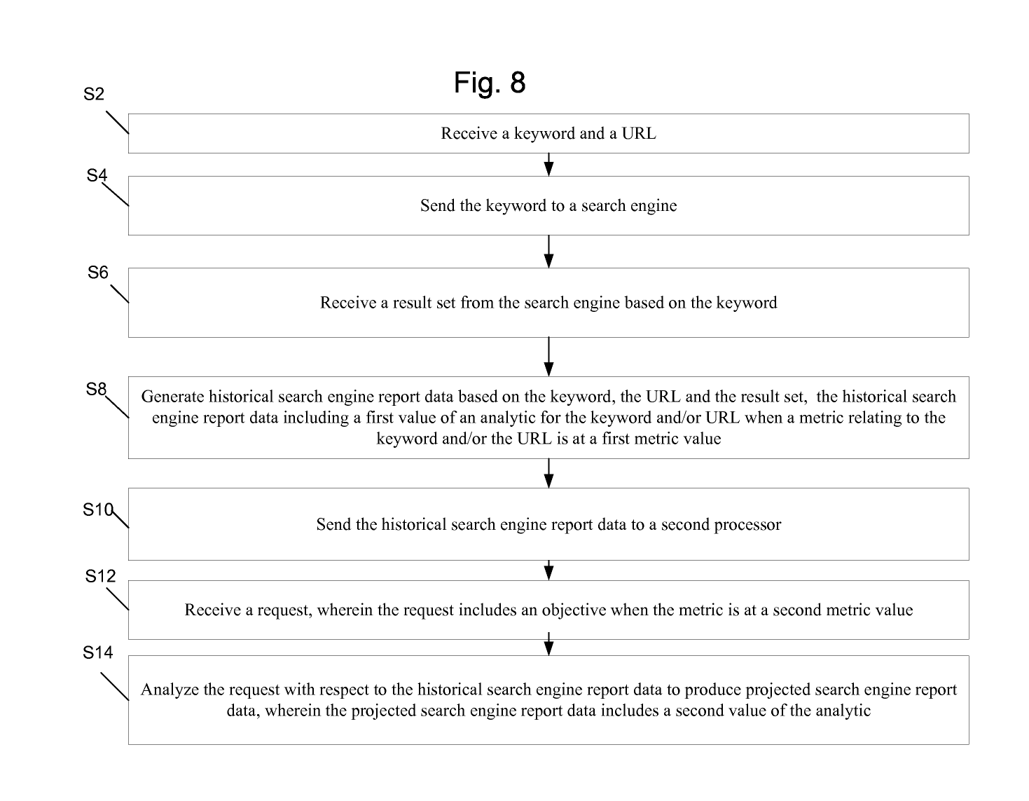

Referring to FIG. 8, there is shown a flow chart of a process which may be performed in accordance with an embodiment of the invention. The process of FIG. 8 may be used to generate search engine report data. At a first block S2, a processor may receive a keyword and a URL. At block S4, the processor may send the keyword to a search engine. At block S6, the processor may receive a result set from the search engine based on the keyword.

At block S8, the processor may generate historical search engine report data based on the keyword, the URL and the result set. The historical search engine report data may include a first value of an analytic for the keyword and URL when a metric relating to the keyword and/or the URL is at a first metric value. At block S10, the processor may send the historical search engine report data to a second processor. At block S12, the processor may receive a request including an objective when the metric is at a second value. The objective may be generated by a processor through movement of an indicator on a slider to indentify the second value.

At block S14, the processor may analyze the request with respect to the historical search engine report data to produce projected search engine report data. The projected search engine report data may include a second value for the analytic. The analytic may relate to a projected number of visits to the URL. The processor may cause the projected search engine report data including the second number of projected visits to be displayed on a display. The historical search engine report data may be displayed with a first shade or color and the projected search engine report data may be displayed with a second shade or color.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating search engine report data, the method comprising, by a first processor:
receiving a keyword and a URL;
sending the keyword to a search engine;
receiving a result set from the search engine based on the keyword;
generating historical search engine report data based on the keyword, the URL and the result set, the historical search engine report data including a first value of an analytic for the keyword and/or URL when a metric relating to the keyword and/or the URL is at a first metric value;
sending the historical search engine report data to a second processor;
receiving a request, wherein the request includes an objective when the metric is at a second metric value; and
analyzing the request with respect to the historical search engine report data to produce projected search engine report data, wherein the projected search engine report data includes a second value of the analytic.

2. The method of claim 1, further comprising sending the projected search engine report data to the second processor.

3. The method of claim 1, further comprising displaying the historical search engine report data and the projected search engine report data on a display.

4. The method of claim 1, further comprising:
displaying the historical search engine report data on a display with a first shade or color; and
displaying the projected search engine report data on the display with a second shade or color different from the first shade or color.

5. The method of claim 1, further comprising displaying the historical search engine report data and the projected search engine report data on a display; and displaying a slider identifying values for the metric.

6. The method of claim 1, wherein the analytic is a number of visits to the URL.

7. The method of claim 1, further comprising determining the second value of the analytic based on a percentage of the second metric value.

8. A device effective to generate report data to be displayed on a display, the device comprising:
a memory;
a first processor configured in communication with the memory, the first processor effective to:
receive a keyword and a URL;
send the keyword to a search engine;
receive a result set from the search engine based on the keyword;
generate historical search engine report data based on the keyword, the URL and the result set, the historical search engine report data including a first value of an analytic for the keyword and/or URL when a metric relating to the keyword and/or the URL is at a first metric value;
send the historical search engine report data to a second processor;
receive a request, wherein the request includes an objective when the metric is at a second metric value; and
analyze the request with respect to the historical search engine report data to produce projected search engine report data, wherein the projected search engine report data includes a second value of the analytic.

9. The device of claim 8, wherein the first processor is further effective to send the modified search engine report data to the second processor.

10. The device of claim 8, wherein the first processor is further effective to cause the historical search engine report data and the modified search engine report data to be displayed on a display.

11. The device of claim 8, wherein the first processor is further effective to:
cause the historical search engine report data to be displayed on a display with a first shade or color; and
cause the projected search engine report data to be displayed on the display with a second shade or color different from the first shade or color.

12. The device of claim 8, wherein the first processor is further effective to:
cause the historical search engine report data and the projected search engine report data to be displayed on a display; and
cause a slider identifying values for the metric to be displayed on a display.

13. The device of claim 8, wherein the analytic is a number of visits to the URL.

14. The device of claim 8 wherein the first processor is further effective to determine the second value of the analytic of projected visits based on a percentage of the second value.

15. A system effective to generate report data to be displayed on a display, the system comprising:
a first processor;
a second processor configured in communication with the first processor over a network;
wherein the second processor is effective to send a keyword and URL to the first processor;
the first processor is effective to
receive the keyword and the URL;
send the keyword to a search engine;
receive a result set from the search engine based on the keyword;
generate historical search engine report data based on the keyword, the URL and the result set, the historical search engine report data including a first value of an analytic for the keyword and/or URL when a metric relating to the keyword and/or the URL is at a first metric value; and
send the historical search engine report data to the second processor;
the second processor is effective to receive the historical search engine report data and generate a request, wherein the request includes an objective when the metric relating to the keyword and/or URL is at a second value;
the first processor is effective to
receive the request; and
analyze the request with respect to the historical search engine report data to produce projected search engine report data, wherein the projected search engine report data includes a second value of the analytic.

16. The system of claim 15, wherein the first processor is further effective to send the modified search engine report data to the second processor.

17. The system of claim 15, wherein the second processor is further effective to cause the historical search engine report data and the modified search engine report data to be displayed on a display.

18. The system of claim 15, wherein the second processor is further effective to:
cause the historical search engine report data to be displayed on a display with a first shade or color; and
cause the projected search engine report data to be displayed on the display with a second shade or color different from the first shade or color.

19. The system of claim 15, wherein the second processor is further effective to:
cause the historical search engine report data and the projected search engine report data to be displayed on a display; and
cause a slider identifying values for the metric to be displayed on the display.

20. The system of claim 15, wherein the second processor is further effective to:
cause the historical search engine report data and the projected search engine report data to be displayed on a display; and
cause a slider identifying values for the metric to be displayed on a display;
wherein the objective is generated in response to movement of an indicator on the slider to identify the second value for the metric.
